(19) United States
(12) Patent Application Publication
(10) Pub. No.: US 2008/0190952 A1
(43) Pub. Date: Aug. 14, 2008

(54) Dispensing Device, Product Support, and Packaging Unit Comprising Said Product Support and Dispensing Device

(75) Inventors: Nikolai Strub, Kaltenkirchen (DE); Cord Wohltmann, Hamburg (DE); Gottfried von Bismarck, Hamburg (DE); Erich Specker, Altstatten (CH)

Correspondence Address: VENABLE LLP, P.O. BOX 34385, WASHINGTON, DC, 20043-9998, US

(73) Assignee: KÖRBER AG, Hamburg (DE)

(21) Appl. No.: 11/596,921

(22) PCT Filed: May 13, 2005
(86) PCT No.: PCT/EP05/05442

§ 371 Date: Nov. 17, 2006

(30) Foreign Application Priority Data
May 17, 2004 (DE) 10 2004 025 136.3

(51) Int. Cl. B65D 83/04; G07F 11/66

(52) U.S. Cl. 221/2; 221/25; 221/74

(57) ABSTRACT

The invention concerns a dispenser device for products arranged in or on a product carrier, in particular tablets or the like, including a holding receptacle for forming a holding chamber for the product carrier, and an actuating means for actuating the dispenser device, a safety element being associated with the actuating means for controlled actuation, which is distinguished in that the actuating means is a pivot lever which is simultaneously designed as a push-out element for pushing the products out of the product carrier. Further, the invention concerns a product carrier for holding products, in particular tablets or the like, which is distinguished in that the product carrier is individually designed such as to be structurally adaptable on the key and lock principle to a corresponding dispenser device. Further, the invention concerns a packaging unit with a product carrier and a dispenser device.

The invention concerns a dispenser device for products arranged in or on a product carrier, in particular tablets or the like, including a holding receptacle for forming a holding chamber for the product carrier, and an actuating means for actuating the dispenser device. Further, the invention concerns a product carrier for holding products, in particular tablets or the like. Further, the invention concerns a packaging unit, consisting of dispenser device and product carrier.

Articles of this kind are used in particular in the pharmaceutical industry. A large number of products, namely e.g. tablets, pills, capsules or the like, are arranged in or on product carriers, e.g. so-called blister packs or blister strips. To make it easier for the patients to take the drugs, there are so-called compliance packs. With packs of this kind, firstly it is easier to remove the drug from the pack. Secondly, packs of this kind are also intended to provide assistance to the patient in dosing and timing of drug-taking. Such compliance packs must meet various criteria before approval is given. Several aspects play a relevant part here. It is particularly important that the drugs, preferably tablets or pills, are easy to remove in order to allow older people who e.g. suffer from disorders of the locomotor apparatus or nervous disorders and are no longer very strong to remove the drug from the pack as well. This criterion is known by the key word “senior-friendliness” (SF). ON the other hand, however, it is of equal importance that the drugs are protected against unauthorised removal, particularly by children. This criterion, known by the keyword “child-resistance” (CR), is basically in contradiction to SF. A further criterion consists of assisting the patient with dosing and/or the drug-taking cycle. Known dispenser devices with the features of the preamble of claim 1 have for example a trigger button by the actuation of which the product carrier is conveyed by a drive means in the direction of a removal opening. A section of the usually perforated product carrier can then be separated manually. However, the drug is still located within the product carrier section. Actual compliance control therefore cannot take place at all. A dispenser device of this kind is of course easy to actuate in the sense of SF. The problem lies in that in particular children also have access to the drug due to the ease of operation/actuation. To prevent this, known product carriers have e.g. special closure films for preventing removal by children. At the same time in turn removal is also made more difficult for older and/or sick people by this design. Perforations or other aids which would facilitate removal for the patients again lead to inadequate child safety, however. Known packaging units with the dispenser devices and product carriers which are common on the market therefore do not meet the above criteria with the desired results.

It is therefore the object of the present invention to provide a dispenser device which ensures on the one hand easier removal and operation and, on the other hand, improved childproofing. Furthermore, it is the object of the invention to propose a product carrier which can be combined with a corresponding dispenser device for easy removal/operation and childproof storage. Furthermore, it is the object of the invention to propose an improved packaging unit consisting of dispenser device and product carrier.

The invention is firstly achieved by a dispenser device with the features of the preamble of claim 1 by the fact that associated with the actuating means is a safety element for controlled actuation. With this design, firstly childproof safekeeping of drugs is ensured in a particularly simple and effective manner, because particularly small children are not yet able to carry out controlled actuation. Secondly, however, removal of the drugs is also safe and easy for people/patients with no strength and/or with movement disorders.

Preferably, the safety means is designed as a locking element such that co-ordinated locking and/or unlocking is necessary. As a result, particularly effective childproofing is achieved, at the same time with easy handling for adults.

In a preferred embodiment of the invention, the locking element is designed to perform at least two independent movements. This actuation, which is easy for any adult, but impossible for children, particularly babies and small children, allows the object of the invention to be achieved in a particularly simple and safe manner.

Advantageously, the locking element has a locking lever movable in at least two directions. As a result, structurally particularly simple and cheap implementation of the principle of the invention is possible.

Preferably, the locking lever can be tensioned by means of a first spring element, ensuring a fixing which is safe, but easy to release for persons capable of co-ordination.

In a further advantageous embodiment, the locking element has a second spring element which can be functionally connected to the actuating means. Due to this embodiment, an even greater co-ordination capacity is required, which on the one hand increases child safety, that is, CR, but on the other hand still ensures ease of operation/removal of drugs by adults even when they are older and/or frail, and so fulfils SF.

In an advantageous development of the invention, the pivot lever is simultaneously designed as a push-out element for pushing the products out of the product carrier, the pushout element being a material projection arranged on the pivot lever. This both simple and effective solution allows the products to be pushed out with minimum effort. A precondition of this is, however, that the pivot lever as an actuating means has been unlocked beforehand. This means that the locking system of the actuating means is not easy for children to overcome due to the necessary co-ordination capacity, but it is easy for adults. Once the locking system has been overcome, the pivot lever with the push-out element allows the products to be pushed out of the product carrier almost without effort. Hence the use of product carriers which have no removal aids, e.g. perforations, predetermined break points or the like, is possible, which in turn increases child safety. Older people can easily perform the push-out operation with the dispenser device standing on a fixed substrate, e.g. a table.

It is particularly advantageous if in addition a separating element for separating individual sections from the product carrier is arranged on the pivot lever. As a result, the product carrier can be “divided into portions” without additional effort. This means that the empty sections of the product carrier can be separated from the still-full product carrier and disposed of almost simultaneously.

Preferably, the holding receptacle has a lockable loading flap for the product carrier. Due to this top-up system, the holding receptacle or the whole dispenser device is reusable. Due to the locking means, the holding chamber is protected against access by children.

Secondly, the object is achieved by a product carrier with the features of the preamble of claim 32 by the fact that the product carrier is individually designed such as to be structurally adaptable on the key and lock principle to a corresponding dispenser device, in particular according to any of claims 1 to 31. This ensures that generally already childproof product carriers can be used, because pushing out by means of a dispenser device is smooth with the actuating means unlocked.

The object is also achieved by a packaging unit with the features of claim 37. Due to the unit composed of dispenser device and product carrier, the requirements which initially appear to be contradictory are met optimally. The packaging unit according to the invention has the advantages already described above, so that reference is made to this to avoid repetition.

Further preferred features and embodiments of the invention are apparent from the subsidiary claims and the description. Some particularly preferred embodiments are described in more detail with the aid of the attached drawings. The drawings show:

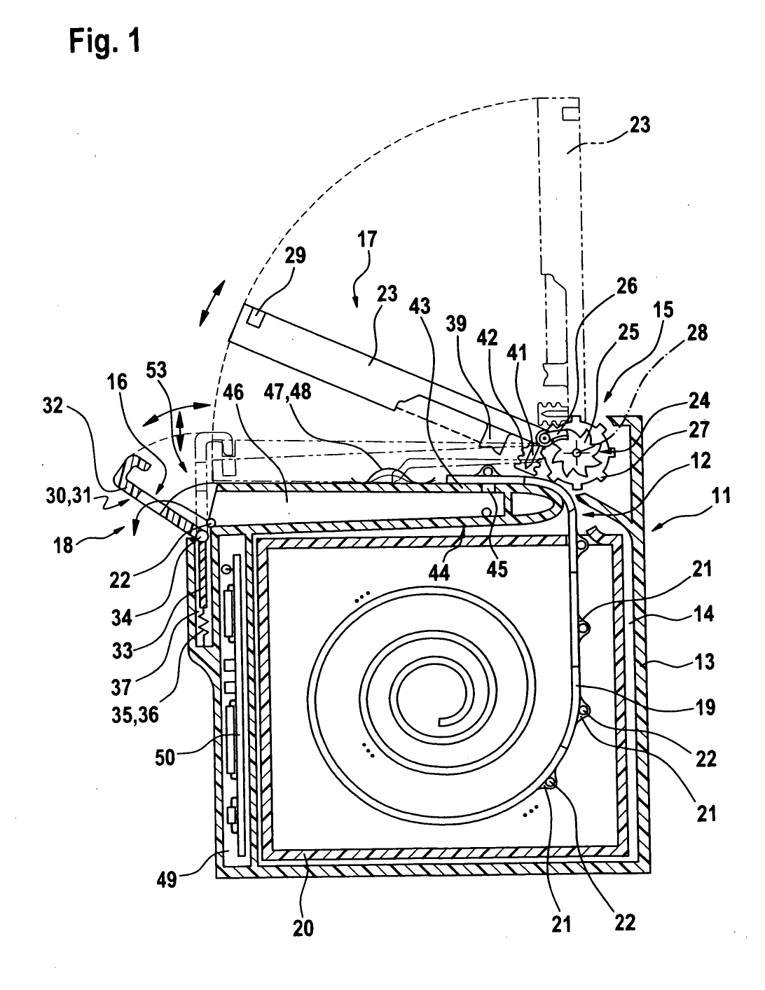

FIG. 1 a side view of a packaging unit, consisting of dispenser device and product carrier in section,

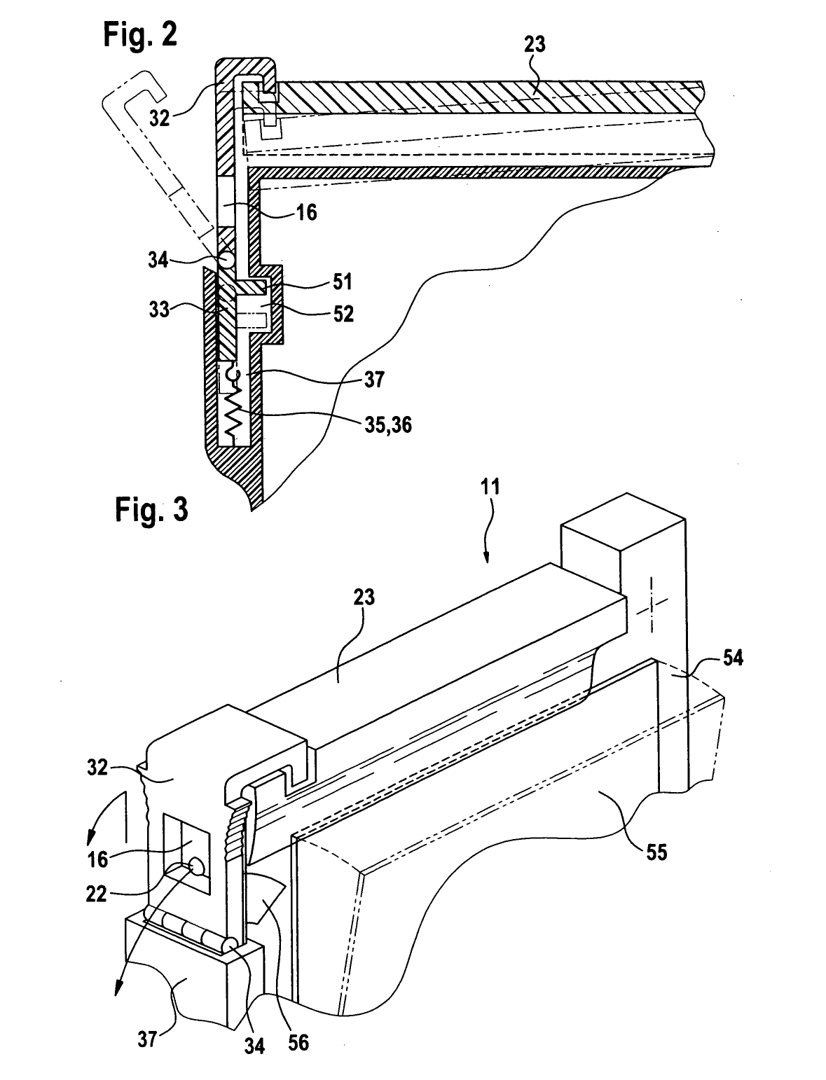

FIG. 2 a detailed drawing of the closing mechanism of the dispenser device,

FIG. 3 a perspective view of the dispenser device from obliquely above and obliquely to the front,

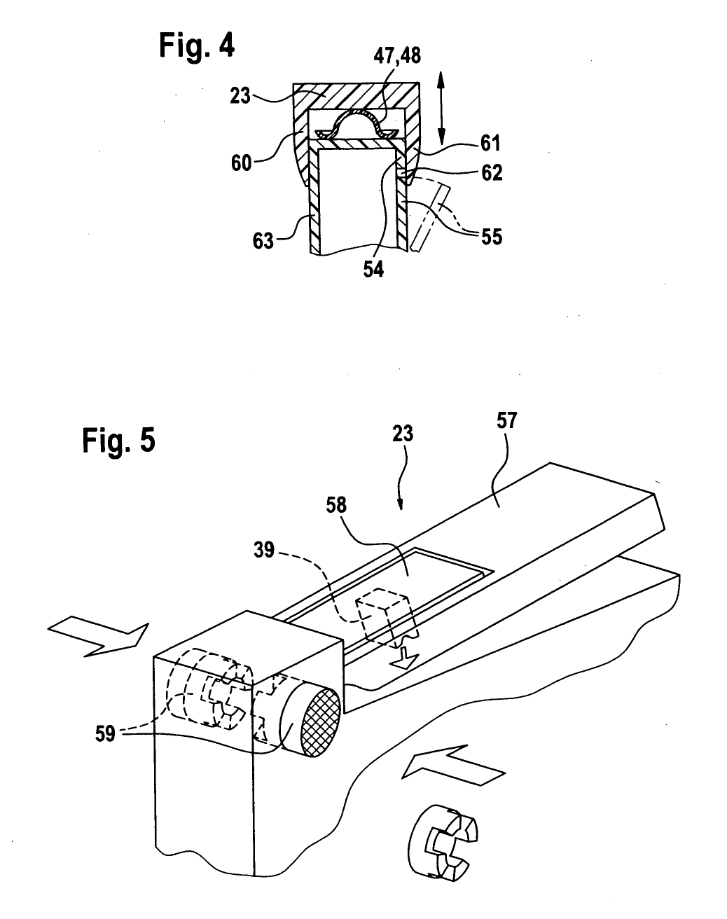

FIG. 4 a front view of the discharge opening of the dispenser device,

FIG. 5 a perspective view of a further embodiment of the dispenser device from obliquely above and obliquely to the front,

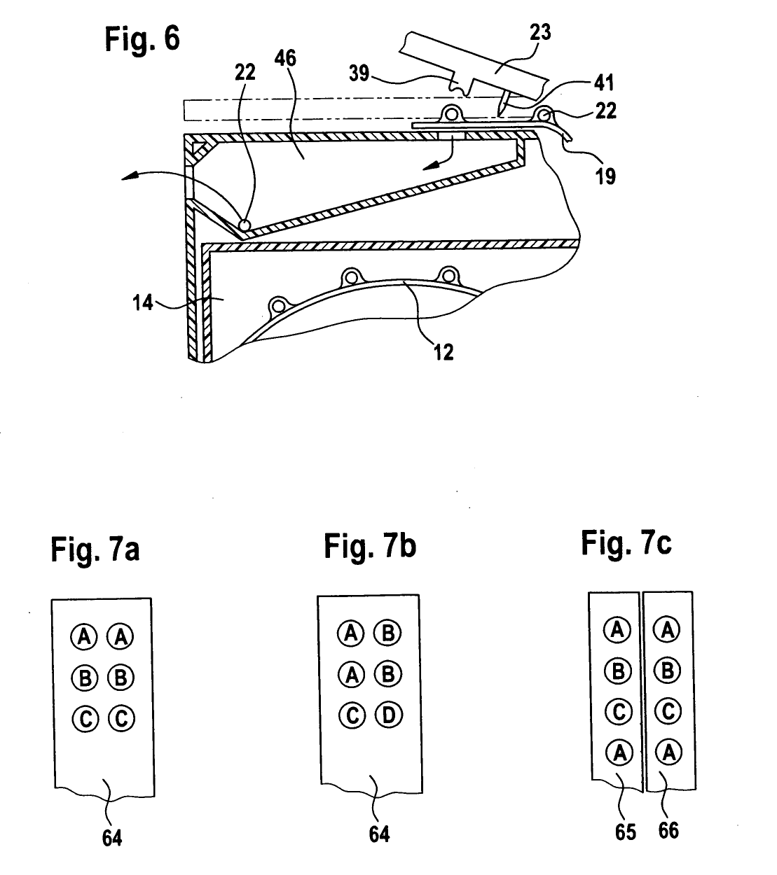

FIG. 6 a side view of a discharge shaft of the dispenser device in section,

FIGS. 7a to 7c various embodiments of blister strips or blister strip assemblies,

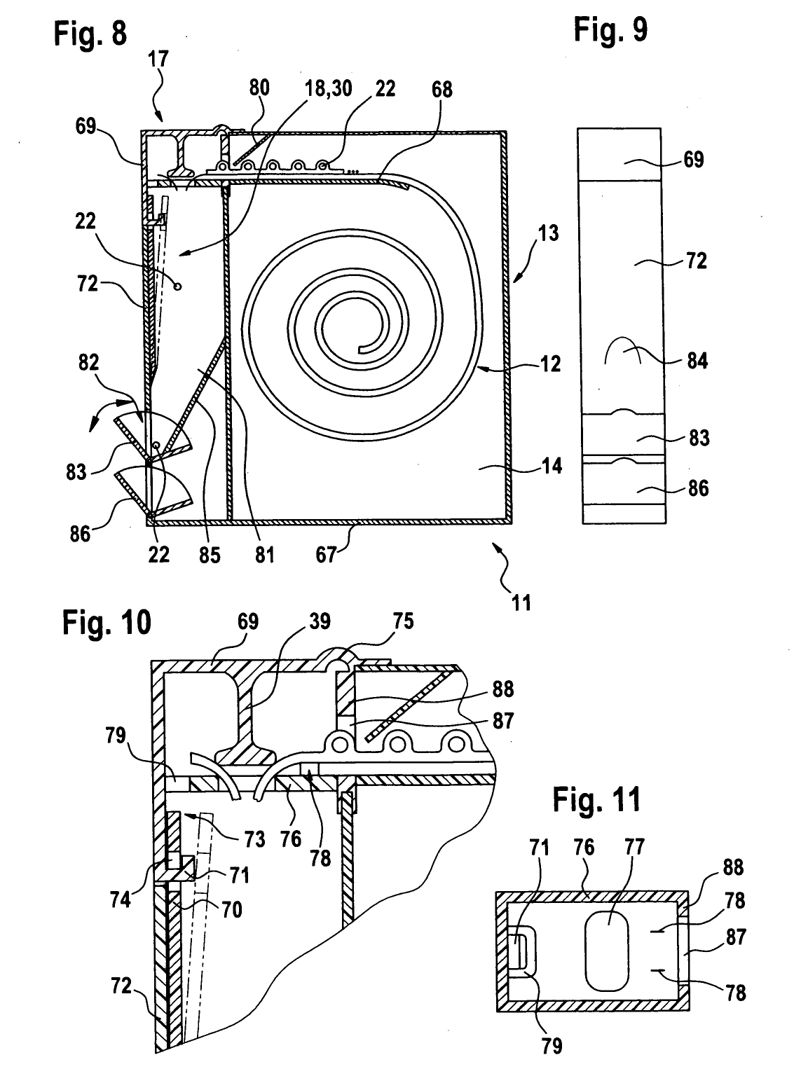

FIG. 8 a side view of a further embodiment of a dispenser device,

FIG. 9 a front view of the dispenser device as in FIG. 8,

FIG. 10 a detailed drawing of the closing mechanism of the dispenser device as in FIG. 8, and

FIG. 11 a sectional view along section AA of FIG. 10.

The articles shown serve in particular for the safekeeping, dosing and discharge of drugs which are arranged e.g. in or on a rolled-up blister strip.

In FIG. 1 is shown a packaging unit 10 which includes a dispenser device 11 and a product carrier 12. The dispenser device 11 has a holding receptacle 13, that is, a housing, for forming a holding chamber 14 for the product carrier 12, a conveying means 15 for conveying the product carrier 12 into the region or in the direction of a discharge opening 16, and an actuating means 17 for actuating the conveying means 15. The dispenser device 11 or the holding receptacle 13 can be designed as a mass-produced article in the form of a folding box made of cardboard or the like or as a reusable injection moulding or the like, that is, e.g. as a fixed box or similar. Associated with the actuating means 17 is a safety element 18 for controlled actuation. The product carrier 12 which is arranged in the holding chamber 14 consists in the embodiment shown in FIG. 1 of a rolled-up blister strip 19 which is preferably arranged in a surrounding package 20, e.g. a folding box made of cardboard or the like. In or on the blister strip 19 in so-called nests 21 are arranged the products 22, that is, tablets, pills, capsules or the like. Alternatively, the blister strip 19 can also be arranged directly in the dispenser device 11 which then serves as a surrounding package 20, the conveying means 15 and actuating means 17 then forming part of the surrounding package 20 e.g. made of cardboard or the like.

The actuating means 17 is designed as a pivot lever 23 and functionally connected to the conveying means 15. The conveying means 15 is designed as a pawl freewheel 24 and has a pawl wheel 25, a pawl 26 and at least one conveying wheel 27. Pawl wheel 25 and conveying wheel 27 are mounted rotatably on a common spindle 28, pawl wheel 25 and conveying wheel 27 being connected to each other for synchronous movement. The pivot lever 23 is also mounted rotatably on the spindle 28. The spindle 28 is arranged on the holding receptacle 13. The pawl 26 is arranged rotatably on the pivot lever 23. The or each conveying wheel 27 is designed as a gear, the shape and pitch of the teeth being adapted to a corresponding perforation of the blister strip 19. By engagement of the teeth 29 in the perforation and clockwise actuation of the pivot lever 23 and the resulting rotary movement of the pawl wheel 25 and hence also of the conveying wheel 27 in the clockwise direction, the blister strip 19 can be conveyed stepwise, preferably by the distance of an interval between nests, in the direction of the removal opening 16.

In the embodiment shown, a clockwise pivot movement of the pivot lever 23 accordingly leads to a conveying movement of the blister strip 19. During the anticlockwise movement freewheeling is provided. This means that the pivot lever 23 is pivotable anticlockwise, but the conveying means 15 does not follow the movement. The pivot lever 23 is pivotable, after the conveying movement has taken place, into its original or locking position. In the locking position, the safety element 18 engages in a recess 29 provided for this purpose. The safety element 18 itself is designed as a locking element 30 such that coordinated locking and/or unlocking is necessary. The locking element 30 is designed to perform at least two independent movements. For this purpose the locking element 30 has a locking lever 31 movable in at least two directions.

The locking lever 31 is designed in two parts. An upper part 32 and a lower part 33 of the locking lever 31 are connected to each other by a hinge 34, so that the upper part 32 is pivotable relative to the lower part 33. The locking lever 31 can be tensioned by means of a first spring element 35 which is designed as a tension spring 36. Alternatively, the spring element 35 can also be designed as a compression spring or in some other ordinary manner. By means of the tension spring 36, the locking lever 31 or, to be more precise, the lower part 33 is attached to the holding receptacle 13. To perform a linear movement, at least the lower part 33 of the locking lever 31 is arranged or guided in a guide 37. The upper part 32 is preferably arranged outside the guide 37 to perform the pivot movement. At its free end 38 opposite the hinge 34, the upper part 32 is hook-shaped. The hook shape matches the recess 29 of the pivot lever 23.

The pivot lever 23 has, on the side facing towards the holding chamber 14 or blister strip 19, at least one push-out element 39 for pushing out the products 22. The push-out element 39 is in the embodiment shown a material projection designed as a stamped bolt and as such is an integral part of the pivot lever 23. Other designs, for example releasably mounted stamped elements or the like, can be used as well. To improve the leverage, the push-out element 39 is arranged at a distance from the free end 40 of the pivot lever 23 near the region of the conveying means 15. Preferably, between the conveying means 15 and the push-out element 39, that is, in front of the push-out element 39 in the conveying direction of the blister strip 19, is arranged a separating element 41 which serves to separate individual sections from the product carrier 12 or blister strip 19. The separating element 41 is blade-like and surrounded by a protective concertina 42. However, the position and/or design of the separating element 41 can vary in the usual way.

At least in the region of the push-out element 39, but preferably also in the region of the separating element 41, is arranged a counter-support 43. The blister strip 19 lies with a nest 21 which is still filled with a product 22 on a shaft-like support element 44 which simultaneously serves as a counter-support 43. The support element 44 has directly in the region of the push-out element 39 an opening 45 for passage of the product 22, where the product 22 falls through the shaft-like design quasi-automatically, namely by tipping the dispenser device 11, into the region of the discharge opening 16. The support element 44 is part of the holding receptacle 13 and simultaneously designed as an ejection shaft 46. On the support element 44 on the side facing towards the pivot lever 23 is arranged a second spring element 47. The spring element 47 is designed as a spring-steel plate 48 or the like. The spring-steel plate 48 is part of the locking element 30 and can be functionally connected to the actuating means 17 or, to be more precise, the pivot lever 23. The spring force of the second spring element 47, namely the spring-steel plate 48, counteracts the spring force of the first spring element 35, namely in this embodiment the tension spring 36.

Furthermore, inside the holding receptacle 13, preferably inside a chamber 49 separate from the holding chamber 14, is arranged an electronic unit 50. The electronic unit 50 serves as a compliance monitor, particularly for transmitting signals to the patient. For this purpose the electronic unit 50 is connected to an acoustic, optical or other ordinary signal transmitter (not shown). The electronic unit 50 can be equipped with different functional units and/or connected to control and/or regulating elements, not shown, e.g. sensor elements or the like. As a result, e.g. each cycle operation can be recorded by e.g. detecting each movement of the pivot lever 23 by means of sensor elements. Further, by means of suitable, preferably patient-specific programs, the functional unit 50 allows the display or indication of removal e.g. by a signal transmitter, preferably LCD displays or the like arranged on the end face of the dispenser device 11.

FIGS. 2 to 6 show further embodiments of the invention. FIG. 2 shows, for example, a detail of the locking lever 31. On the lower part 33 is arranged a stop element 51 which is designed as a material projection. The stop element 51 engages in a corresponding recess 52 of the holding receptacle 13. The recess 52 predetermines a precise distance of movement of the locking lever 31 in a linear, preferably vertical direction, which limits upward and downward movement. Furthermore, in the upper part 32 of the locking lever 31 is provided the discharge opening 16. The discharge opening 16 is arranged in the upper part 32 in such a way as to be also closed in the closed state of the safety element 18. For this purpose the upper part 32 with the discharge opening 16 preferably abuts against the end face of the pivot lever 23, so that even a product 22 already pushed out of the product carrier 12 and located in the ejection shaft 46 is protected against access by children. For discharge of the product 22, first the safety element 18 is to be actuated, so that discharge through the discharge opening 16 is possible in the unlocked state by tipping the whole dispenser device 11. The product 22 is prevented from falling out sideways by lateral wing elements 56 in the region of the upper part 32. In the unlocked state of the safety element 18 a further opening 53 is formed, which can serve to discharge the product 22.

In FIG. 3, a part of a side wall 54 of the holding receptacle 13 is designed as a loading flap 55. The loading flap 55 serves to remove a fully emptied product carrier 12 and to insert a new, full product carrier 12. The loading flap 55 is lockable. Locking is achieved by an extension of the side walls 60, 61 of the pivot lever 23. The side walls 60, 61 in the locked state of the pivot lever 23 protrude beyond the loading flap 55 (see e.g. FIG. 4), so that the slot 62 between loading flap 55 and side wall 54 is concealed. In the unlocked state, however, the holding chamber 14 is readily accessible.

In FIG. 5 is shown a further locking or unlocking mechanism. In this embodiment the pivot lever 23 is in two parts, namely a conveying lever 57 and a push-out lever 58. Only by simultaneously pushing together mutually opposed coupling elements 59 which can be brought into form-locking engagement with each other by actuation, is a synchronous movement of the whole pivot lever 23 ensured, and hence unlocking and pushing out of the product.

FIG. 6 shows a further embodiment of the ejection shaft 46 which by deflection prevents direct exit of the product 22 from the ejection shaft 46. Hence the products 22 are prevented from falling to the floor. To remove the product 22 from the ejection shaft 46, a tipping movement is required.

In embodiments not shown, the pivot lever 23 can also have several push-out elements 39, so that several drugs which can possibly be taken together can be simultaneously pushed out of the product carrier 12. The pivot lever 23 can also be made removable, so that only directly before removal can the latter be stood up and immediately afterwards taken off again. Hence unauthorised access is prevented.

In the region e.g. of the loading flap 55 can also be removably arranged e.g. a CD-ROM or the like, an accessories pack slip or other information carriers. Preferably, however, on the side opposite the loading flap 55 in the region of the side wall 63 is optionally provided a so-called information flap, a slot for keeping information material, a releasably attached booklet or the like. In the region of the side walls 54, 63, preferably on the loading flap 55, a calendar sheet or the like can be arranged e.g. on the inside for compliance control. To facilitate removal, particularly for Parkinson's patients, an adhesive strip (not shown) can be provided on the lower side of the dispenser device 11.

The product carrier 12 can be designed as desired, e.g. as a single, double or multiple strip. To increase compliance it is normal to administer combination preparations. These can be arranged on several individual blister strips parallel and adjacent to each other or in groups, but also on a single blister strip for parallel discharge. In other words, firstly a single blister strip 64 with two or more identical (for higher dosage, see FIG. 7a) or different (for combination preparation, see FIG. 7b) products 22 arranged adjacent to each other is possible. Secondly, two or more single-track blister strips 65, 66 adjacent to each other in a dispenser device 11 or surrounding package 20 with comparable product arrangement is possible (FIG. 7c). Lastly, a combination of several product carriers 12 arranged in surrounding packages 20 is possible, by joining together the surrounding packages 20 by suitable bayonet or hook fastenings or by adhesive strips or the like and arranging them inside a common dispenser device 11. The blister strips 19, 64, 65, 66 can be provided with or without predetermined break points, where the predetermined break points can be designed to increase compliance between the individual nests 21 and/or in the cover film in each case above the nests 21.

In FIGS. 8 to 11 can be seen a further embodiment of the dispenser device 11 with essential details. The dispenser device 11 of FIG. 8 is designed as a folding box 67 made of cardboard or the like and as a mass product is a disposable article. Inside the folding box 67 is arranged the product carrier 12, preferably a rolled-up blister strip 19 or the like. The product carrier 12 rests on a substrate 68 which is made of cardboard or the like. The product carrier is movable manually in the direction of the actuating means 17 which is designed as a closure lid 69.

The safety element 18, that is, the locking element 30 for the actuating means 17 or the closing lid 69, has a spring element 70 and a closing hook 71. Spring element 70 and closing hook 71 can be functionally connected to each other to lock the dispenser device 11. The spring element 70 is preferably designed as a single cardboard strip or the like and arranged or attached by one end to an end wall 72 of the folding box 67, and at its free end 73 has an eye-like opening 74 for receiving the closing hook 71. The closing hook 71 itself is arranged on the closing lid 69 or is part of it. In addition, on the closing lid 69 is arranged the push-out element 39 in the form of a plunger or the like. The closing lid 69, which is preferably made of plastic, e.g. polypropylene, is directly or indirectly attached to the folding box 67 with a cover plate element 75. The cover plate element 75 allows on the one hand a pivot movement and on the other hand a limited linear movement of the closing lid 69.

As a counter-support for the push-out element 39 is provided a grid 76, preferably also made of plastic, which has an opening 77 for the products 22 to fall through (see in particular e.g. FIG. 11). In front of the opening 77 in the conveying direction of the product carrier 12 is arranged a scoring element 78, namely e.g. at least one tearing blade, which scores the side of the product carrier 12 facing towards the scoring element 78, so that even arthritis patients can easily push the products 22 out of the product carrier 12. The scoring element 78 is preferably designed in one piece with the grid 76. Behind the opening 77 in the conveying direction of the product carrier 12 is formed an aperture 79 for the closing hook 71. On the side of the product carrier 12 opposite the substrate 68 is arranged a spring element 80, preferably made of cardboard, by means of which the product carrier 12 can be pushed towards the substrate 68.

Below the grid 76 is formed an ejection shaft 81 which has at least one discharge opening 82. The discharge opening 82 is formed in the region of the end wall 72 and closed by a flap 83. The flap 83 is arranged pivotably on the end wall 72 for opening and closing the discharge opening. In addition, in the region of the end wall 72 is provided an actuating area 84 for actuating the locking and unlocking mechanism. Preferably the actuating area 84 is a U-shaped notch in the end wall 72. However, e.g. an opening can also be provided in the end wall 72, through which the spring element 70, namely the cardboard strip, is releasable by pressing out of functional connection to the closing hook 71. Inside the ejection shaft 81 an oblique plane 85 is formed e.g. from a cardboard strip, by means of which the products 22 can be guided directly into the region of the flap 83. Below the flap 83 can optionally be arranged a further flap 86 for closing a storage box e.g. for tablet remains or the like.

The dispenser device 11 as in FIG. 8 can of course also be provided with all the options described for the dispenser device 11 as in FIG. 1, e.g. conveying means 15, electronic unit 50.

Below, the principle of handling the dispenser device 11 or packaging unit 10 as in FIG. 1 is described in more detail.

The dispenser device 11 is filled via the loading flap 55 with a rolled-up blister strip 19 arranged in a surrounding package 20, or directly with the blister strip 19. The blister strip 19 is fed into the conveying means 15, so that the teeth of the conveying wheel 27 latch or engage in the lateral perforation of the blister strip 19 extending in the direction of conveying. The pivot lever 23 is locked in its rest or closing position (see e.g. FIGS. 2 and 3) and by the safety means 18. For removal, the pivot lever 23 must now be pushed down with one hand against the spring force of the spring-steel plate 48. At the same time the locking lever 31 is to be pulled up with the other hand in the opposite direction against the spring force of the tension spring 36. As soon as engagement of the hook-shaped section of the upper part 32 of the locking lever 31 is released from the recess 29, the upper part 32 automatically pivots outwards by means of spring elements, not shown explicitly, in the region of the hinge 34, away from the dispenser device 11. Then the pivot lever 23 is unlocked. By pivoting the pivot lever 23 clockwise, the conveying means 15 is actuated and leads to the blister strip 19 moving by one nest position in the direction of the discharge opening 16, so that a nest 21 filled with a product 22 is located above the opening 45. By pivoting the pivot lever 23 anticlockwise, that is, in the free-wheeling direction, the product 22 is pushed by the push-out element 39 out of the nest 21 and falls into the ejection shaft 46. Almost at the same time the section of the blister strip 19 which has just been emptied or is about to be emptied is separated by the separating element 41 from the remaining, still-full blister strip 19. The product 22 rolls or falls through the ejection shaft 46 in the direction of the discharge opening 16 at which the product 22 can be removed by tipping the dispenser device 11. If the blister strip 19 is completely empty, it is exchanged for a new blister strip 19.

The principle of the method or operation of the dispenser device 11 from FIG. 8 is as follows.

The closed dispenser device 11 is opened by performing two independent movements. For this, firstly the spring element 70 must be disengaged from the closing hook 71 by pressing the actuating area 84, and secondly the closing lid 69 must be pivoted upwards. By pivoting the closing lid 69 downwards again, the product 22 is pushed by the plunger out of the product carrier 12 and falls through the opening 77 in the grid 76 over the oblique plane 85 into the region of the flap 83. By opening the flap 83, the product 22 can be removed. On pivoting downwards, the closing hook 71 again latches in the spring element 70, so that the dispenser device 11 is again closed in a childproof manner. For this purpose it may e.g. be necessary to actuate the spring element 70 again, namely to push it inwards, to keep the spring element 70 pushed inwards, to close the closing lid 69 and then to release the spring element 70 so that the closing hook 71 latches in the opening 74 again. Alternatively, closing hook 71 and spring element 70 can be co-ordinated with each other in such a way that, when the closing flap 69 is pivoted downwards, automatic latching takes place. This operation can be repeated until the product carrier 12 is completely empty, the product carrier 12 being moved by pulling into the next removal position. In the process the product carrier 12 is guided through an opening 87 in a rear wall 88 of the closing lid 69.

1. Dispenser device for products arranged in or on a product carrier, in particular tablets or the like, including a holding receptacle for forming a holding chamber for the product carrier, and an actuating means for actuating the dispenser device, a safety element w being associated with the actuating means for controlled actuation, characterised in that the actuating means is a pivot lever which is simultaneously designed as a push-out element for pushing the products out of the product carrier.

2. Dispenser device according to claim 1, characterised in that the safety element designed as a locking element such that co-ordinated locking and/or unlocking is necessary.

3. Dispenser device according to claim 2, characterised in that the locking element is designed to perform at least two independent movements.

4. Dispenser device according to claim 2, characterised in that the locking element has a locking lever movable in at least two directions.

5. Dispenser device according to claim 4, characterised in that the locking lever is designed in two parts, the two parts, namely upper part and lower part, being connected to each other by means of a hinge.

6. Dispenser device according to claim 4, characterised in that the locking lever can be tensioned by means of a first spring element.

7. Dispenser device according to claim 6, characterised in that the first spring element is attached on the one hand to the lower part of the locking element and on the other hand to the holding receptacle for performing a linear movement.

8. Dispenser device according to claim 5, characterised in that the upper part of the locking lever is hook-shaped at its free end.

9. Dispenser device according to claim 5, characterised in that at least the lower part of the locking lever is arranged within a guide.

10. Dispenser device according to claim 9, characterised in that the lower part of the locking lever arranged within the guide has a stop element.

11. Dispenser device according to claim 10, characterised in that the stop element is a material projection which engages in a corresponding recess of the holding receptacle.

12. Dispenser device according to claim 2, characterised in that the locking element has a second spring element which can be functionally connected to the actuating means.

13. Dispenser device according to claim 12, characterised in that the spring force of the second spring element counteracts the spring force of the first spring element.

14. Dispenser device according to claim 1, characterised in that in addition a conveying means is provided for conveying the product carrier into the region of a discharge opening.

15. Dispenser device according to claim 14, characterised in that the pivot lever is functionally connected to the conveying means.

16. Dispenser device according to claim 14, characterised in that the conveying means is designed as a pawl freewheel.

17. Dispenser device according to claim 1, characterised in that the push-out element is a material projection arranged on the pivot lever.

18. Dispenser device according to claim 1, characterised in that in addition a separating element for separating individual sections from the product carrier is arranged on the pivot lever.

19. Dispenser device according to claim 1, characterised in that the pivot lever has in the region of its free end a recess for receiving the locking lever.

20. Dispenser device according to claim 1, characterised in that in the region of the push-out element is arranged a support element which simultaneously serves as a counter-support for the push-out element, the support element including an opening for exit of the product to be pushed out.

21. Dispenser device according to claim 20, characterised in that the support element is part of the holding receptacle and at the same time is designed as an ejection shaft for the products to be pushed out of the product carrier.

22. Dispenser device according to claim 1, characterised in that inside the holding receptacle is arranged an electronic unit which is connected to at least one signal transmitter.

23. Dispenser device according to claim 1, characterised in that the holding receptacle has a lockable loading flap for the product carrier.

24. Dispenser device according to claim 23, characterised in that the locking element has at least one lateral wing element for locking the loading flap.

25. Dispenser device according to claim 2, characterised in that the locking element has a spring element and a closing hook which can be functionally connected to each other.

26. Dispenser device according to claim 25, characterised in that the spring element is a cardboard strip or the like which is arranged with one end on an end wall of the dispenser device and has at its free end an opening for receiving the closing hook.

27. Dispenser device according to claim 25, characterised in that the closing hook is arranged on the actuating means.

28. Dispenser device according to claim 25, characterised in that the actuating means is a closing lid, the closing lid being additionally designed as a push-out element for pushing the products out of the product carrier.

29. Dispenser device according to claim 28, characterised in that in the region of the push-out element, which is designed as a plunger, is arranged a counter-support in the form of a grid, the grid including an opening for exit of the product to be pushed out.

30. Dispenser device according to claim 29, characterised in that on the grid are formed in addition an aperture for the closing hook and a scoring element.

31. Dispenser device according to claim 29, characterised in that the holding receptacle is a folding box made of cardboard or the like, and at least the closing lid and preferably also the grid are made of plastic.

32. Product carrier for holding products, in particular tablets or the like, characterised in that the product carrier is individually designed such as to be structurally adaptable on the key and lock principle to a corresponding dispenser device, in particular according to claim 1.

33. Product carrier according to claim 32, characterised in that it is designed as a blister strip that can be rolled up, with at least one lateral perforation.

34. Product carrier according to claim 33, characterised in that the blister strip is designed without predetermined break points.

35. Product carrier according to claim 33, characterised in that the blister strip is arranged in a surrounding package, preferably a folding box made of cardboard or the like.

36. Product carrier according to claim 35, characterised in that the surrounding package is individually designed such as to be structurally adaptable on the key and lock principle to a corresponding dispenser device.

37. Packaging unit consisting of comprising a dispenser device according to claim 1 forming a combination with a product carrier to for said holding products, wherein the product carrier is individually designed to be structurally adaptable on a key and lock principle to said dispenser device.
